(19) United States
(12) Patent Application Publication
(10) Pub. No.: US 2024/0274351 A1
(43) Pub. Date: Aug. 15, 2024

(54) IGNITION COIL

(71) Applicant: DIAMOND&ZEBRA ELECTRIC MFG. CO., LTD., Osaka (JP)

(72) Inventors: Daiki YOSHIHARA, Osaka-shi (JP); Eiji KAWAGUCHI, Osaka-shi (JP)

(73) Assignee: DIAMOND&ZEBRA ELECTRIC MFG. CO., LTD., Osaka (JP)

(21) Appl. No.: 18/414,034

(22) Filed: Jan. 16, 2024

(30) Foreign Application Priority Data
Feb. 13, 2023 (JP) 2023-019841

(51) Int. Cl. H01F 38/12; H01F 27/24

(52) U.S. Cl. CPC H01F 38/12; H01F 27/24

(57) ABSTRACT

An ignition coil includes a primary coil, a secondary coil formed outside the primary coil, and an annular iron core unit. The iron core unit includes: a central iron core extending through the primary coil; an outer iron core having a contact surface in contact with the central iron core, the outer iron core extending from one end of the central iron core and passing outside the secondary coil; and a cover made of an elastomer. The contact surface includes an exposed portion projecting out of the central iron core in an axial direction of the iron core unit. The cover includes a projecting portion covering the exposed portion.

### CROSS-REFERENCE TO RELATED APPLICATION

This application claims priority on and the benefit of Patent Application No. 2023-19841 filed in JAPAN on Feb. 13, 2023. The entire disclosures of the Japanese Patent Application are hereby incorporated by reference.

### BACKGROUND OF THE INVENTION

### Field of the Invention

The present specification discloses an ignition coil of an internal combustion engine.

### Description of the Related Art

An ignition coil of a typical internal combustion engine includes a case, which encloses: a primary coil; a secondary coil located outside the primary coil; a central iron core extending through the center of the primary coil; and an outer iron core extending from one end to the other end of the central iron core by passing outside the secondary coil. Gaps within the case are filled with a filler made of a thermosetting resin.

The ignition coil heats up to a high temperature during use and cools down to ordinary temperature when not in use. The temperature difference induces expansion and contraction of the iron cores, and this could cause cracking in the filler. An investigation of an ignition coil adapted to avoid the filler cracking has been reported in Japanese Laid-Open Patent Application Publication No. 2013-239633. In this ignition coil, a part of the outer iron core is covered by a cover made of an elastomer in order to reduce the area of contact between the filler and the iron cores.

There is a demand for an ignition coil with increased resistance to cracking in a filler.

The present inventors aim to provide an ignition coil adapted to avoid the occurrence of cracking in a filler.

### SUMMARY OF THE INVENTION

An ignition coil according to one embodiment includes: a primary coil; a secondary coil formed outside the primary coil; and an annular iron core unit. The iron core unit includes: a central iron core extending through the primary coil; an outer iron core having a contact surface in contact with the central iron core, the outer iron core extending from one end of the central iron core and passing outside the secondary coil; and a cover made of an elastomer. The contact surface includes an exposed portion projecting out of the central iron core in an axial direction of the iron core unit. The cover includes a projecting portion covering the exposed portion.

Ordinarily, a bobbin for a primary coil is located in the vicinity of the surface (contact surface) of an outer iron core that is in contact with a central iron core, and this bobbin is intended to function to prevent cracking in a filler. However, as a result of an analysis of why cracking occurs, the present inventors have confirmed that the function of the bobbin alone is insufficient to satisfactorily prevent cracking around a portion (exposed portion) of the contact surface that projects out of the central iron core and is exposed to the outside environment. The present inventors have found that this portion is a cause of cracking in the filler. In the ignition coil of the present disclosure, a cover made of an elastomer includes a projecting portion covering the exposed portion. The projecting portion effectively contributes to preventing cracking around the exposed portion. The ignition coil can avoid the occurrence of cracking in the filler.

### BRIEF DESCRIPTION OF THE DRAWINGS

FIG. 1 is a cross-sectional view showing an ignition coil according to one embodiment.

FIG. 2 is a perspective view showing a primary bobbin of the ignition coil of FIG. 1.

FIG. 3 is a perspective view showing an iron core unit of the ignition coil of FIG. 1.

FIG. 4 is an exploded perspective view of the iron core unit of FIG. 3.

FIG. 5 is a side view showing a central iron core and an outer iron core of the iron core unit of FIG. 4.

FIG. 6 is an enlarged perspective view showing parts of the central and outer iron cores of FIG. 5 as viewed from a different viewpoint than in FIG. 3.

FIG. 7 is an enlarged side view showing a right part of the iron core unit of FIG. 3.

FIG. 8 is an enlarged side view showing a left part of the iron core unit of FIG. 3.

FIG. 9 is a rear view showing the primary bobbin of FIG. 2 and the iron core unit of FIG. 3.

### DETAILED DESCRIPTION

The following will describe in detail preferred embodiments with appropriate reference to the drawings.

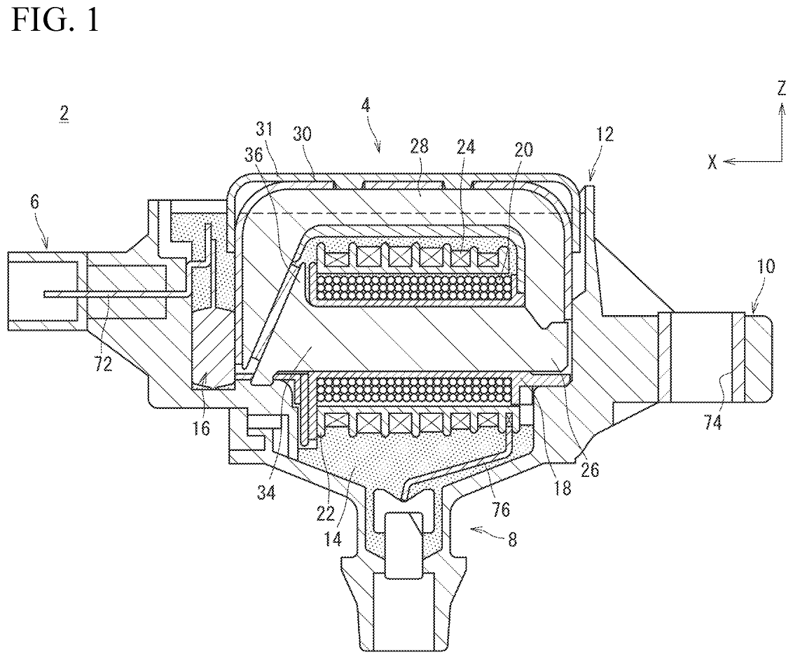

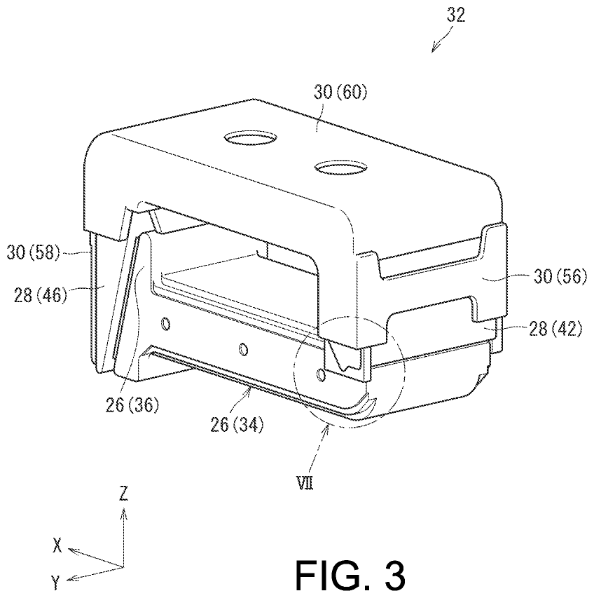

FIG. 1 is a cross-sectional view showing an ignition coil 2 according to one embodiment. In FIG. 1, the arrow X represents the forward direction with respect to the ignition coil 2. The opposite direction is the rearward direction. The arrow Z represents the upward direction with respect to the ignition coil 2. The opposite direction is the downward direction. In FIGS. 3 to 6 described later, the arrows X and Z represent the same directions as in FIG. 1. The ignition coil 2 is for use in an internal combustion engine. As shown in FIG. 1, the ignition coil 2 includes a body 4, a connector portion 6, an output portion 8, and a flange portion 10.

The body 4 is located at the center of the ignition coil 2. The body 4 is box-shaped. The body 4 includes a case 12, a filler 14, an igniter 16, a primary bobbin 18, a primary coil 20, a secondary bobbin 22, a secondary coil 24, a central iron core 26, an outer iron core 28, a cover 30, and a cap 31.

The case 12 is shaped as a box having a hollow interior. The case 12 encloses the filler 14, the igniter 16, the primary bobbin 18, the primary coil 20, the secondary bobbin 22, the secondary coil 24, the central iron core 26, the outer iron core 28, and the cover 30. The case 12 is made of a resin composition. Preferred examples of the material of the case 12 include PBT (polybutylene terephthalate), PPS (polyphenylene sulfide), and PET (polyethylene terephthalate).

The filler 14 fills gaps formed within the case 12 when the components such as the primary coil 20 and secondary coil 24 of the body 4 are placed into the case 12. In this embodiment, the filler 14 is made of a thermosetting resin. To insulate the secondary coil 24, in which a high voltage occurs, from the other components, a thermosetting resin excellent in insulating performance is selected as the material of the filler 14. Since the secondary coil 24 generates heat, the thermosetting resin selected is one excellent in thermal conductivity. Additionally, the thermosetting resin selected as the material of the filler 14 is one which has a low viscosity so that the gaps within the case 12 may be completely filled with the resin. A preferred example of the material of the filler 14 is an epoxy resin. A resin that cures at ordinary temperature may be used as the material of the filler 14.

The igniter 16 is enclosed in the case 12. The igniter 16 is adjacent to the connector portion 6. The igniter 16 is a switch that controls whether to permit or block a current flow to the primary coil 20 based on a signal from the connector portion 6.

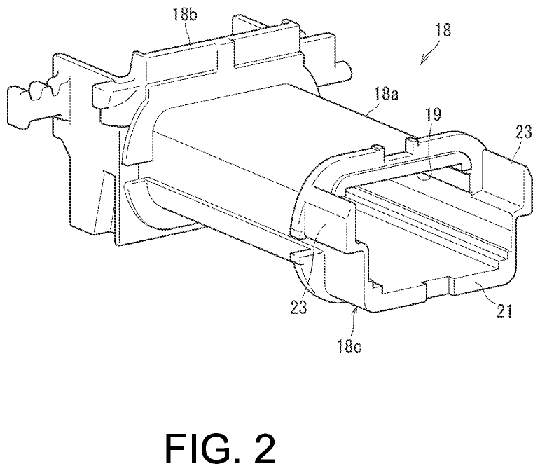

FIG. 2 is a perspective view showing the primary bobbin 18 of the ignition coil 2 of FIG. 1. The primary bobbin 18 includes a middle portion 18a, a front portion 18b, and a rear portion 18c. The middle portion 18a is shaped as a tube extending in the forward/rearward direction. The middle portion 18a includes a hole 19 extending therethrough in the forward/rearward direction. As described later, the central iron core 26 is inserted into the hole 19. The rear portion 18c extends rearward from the rear end of the middle portion 18a. The rear portion 18c includes a receiving portion 21 and a pair of wing portions 23. The primary bobbin 18 is made of a resin composition. Preferred examples of the material of the primary bobbin 18 include PBT, PPS, and PET. The primary coil 20 is formed by winding a primary wire on the outer circumference of the middle portion 18a of the primary bobbin 18. Atypical example of the material of the primary wire is copper (Cu).

The secondary bobbin 22 is shaped as a tube extending in the forward/rearward direction. The secondary bobbin 22 is located outside the primary coil 20. More specifically, the secondary bobbin 22 surrounds the primary coil 20 and is coupled to the primary bobbin 18. The secondary bobbin 22 is made of a resin composition. Preferred examples of the material of the secondary bobbin 22 include modified polyphenylene ether (m-PPE), PBT, PPS, and PET. The secondary coil 24 is formed by winding a secondary wire on the outer circumference of the secondary bobbin 22. The secondary coil 24 is formed outside the primary coil 20. The number of turns of the secondary wire is much greater than the number of turns of the primary wire. Thus, upon a change in the current flowing in the primary coil 20, a high voltage occurs in the secondary coil 24. Atypical example of the material of the secondary wire is copper.

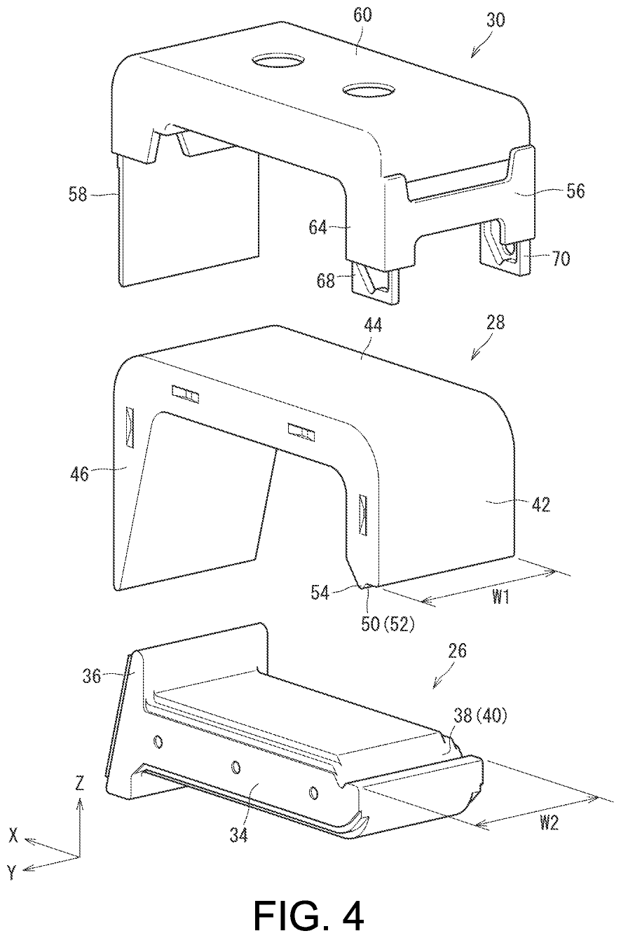

FIG. 3 is a perspective view showing only the central iron core 26, outer iron core 28, and cover 30 of the constituent elements of the ignition coil 2 of FIG. 1. In this specification, the central iron core 26, outer iron core 28, and cover 30 are collectively referred to as an “iron core unit 32”. FIG. 4 is a perspective view of the iron core unit 32 as disassembled into the central iron core 26, outer iron core 28, and cover 30. In FIGS. 3 and 4, the arrow Y represents the rightward direction with respect to the ignition coil 2. The opposite direction is the leftward direction. As shown in FIG. 3, the iron core unit 32 is annular. At the center of the iron core unit 32, there is a hole extending through the iron core unit 32 in the leftward/rightward direction. The leftward/rightward direction corresponds to the axial direction of the iron core unit 32. The outer surfaces of the iron core unit 32 that face in the axial direction correspond to the “side surfaces” of the iron core unit 32.

In this embodiment, as shown in FIG. 4, the central iron core 26 includes a bar portion 34 extending straight and a base portion 36 located at the front end of the bar portion 34. As shown in FIG. 1, the bar portion 34 extends through the center of the primary bobbin 18. The bar portion 34 extends through the center of the primary coil 20. In this embodiment, the bar portion 34 is shaped as a quadrangular prism. A recess 38 is located at the rear end of the upper surface of the bar portion 34. The recess 38 extends in the leftward/rightward direction. As described later, the surface of the recess 38 forms a contact surface 40 that contacts the outer iron core 28. The base portion 36 is plate-shaped. The base portion 36 projects upward and downward from the bar portion 34. The front surface (outer surface) of the base portion 36 is inclined to extend upward and rearward. The central iron core 26 is made of a magnetic material. Preferred examples of the magnetic material include ferrite, dust, and silicon steel.

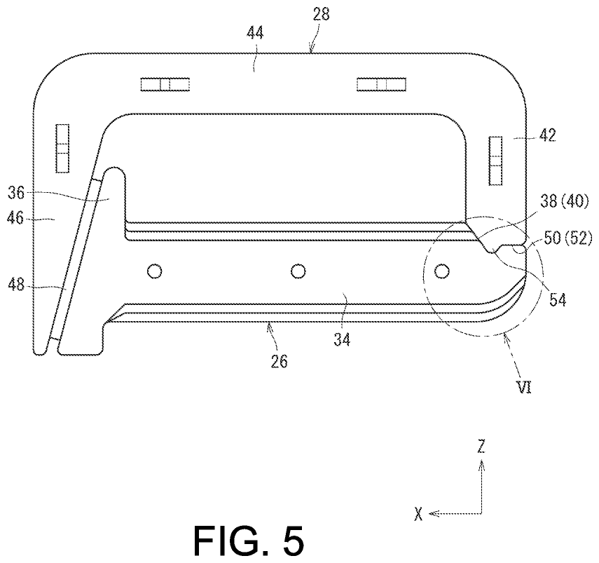

FIG. 5 is a side view showing the central iron core 26 and the outer iron core 28. The outer iron core 28 extends from the rear end of the upper surface of the central iron core 26. As shown in FIG. 3, the outer iron core 28 extends toward the front end of the central iron core 26 by passing outside the secondary coil 24. In this embodiment, as shown in FIG. 4, the outer iron core 28 includes a first pillar portion 42 extending upward from the rear end of the central iron core 26, a beam portion 44 located above the secondary coil 24 and extending parallel to the central iron core 26, and a second pillar portion 46 extending downward from the front end of the beam portion 44. In this embodiment, each of the first pillar portion 42 and the beam portion 44 is shaped as a quadrangular prism. The second pillar portion 46 is shaped to taper downward. As shown in FIG. 5, the inner surface (rear surface) of the second pillar portion 46 faces the front surface of the base portion 36. A magnet 48 is located between the second pillar portion 46 and the base portion 36. The outer iron core 28 is made of a magnetic material. Preferred examples of the magnetic material include ferrite, dust, and silicon steel.

As shown in FIG. 5, a bottom surface 50 of the first pillar portion 42 is in contact with the recess 38 of the central iron core 26. The bottom surface 50 of the first pillar portion 42 forms a contact surface 52. In this embodiment, as shown in FIGS. 4 and 5, the contact surface 52 of the first pillar portion 42 includes a protrusion 54 extending in the leftward/rightward direction. As shown in FIG. 5, the protrusion 54 is fitted in the recess 38 of the central iron core 26. In the side view, the contact surface 52 of the first pillar portion 42 and the contact surface 40 of the central iron core 26 are in contact without any gap between them.

The cover 30 covers the outer iron core 28. As shown in FIG. 4, the cover 30 includes a first portion 56, a second portion 58, and a central portion 60. As shown in FIG. 3, the first portion 56 covers the right side surface and rear surface of the first pillar portion 42. Although not seen in FIG. 3, the first portion 56 further covers the left side surface of the first pillar portion 42. The second portion 58 covers the right side surface, left side surface, and front surface of the second pillar portion 46. The central portion 60 covers the right side surface, left side surface, and upper surface of the beam portion 44. Although not seen in FIG. 3, the central portion 60 further covers the bottom surface of the beam portion 44. The cover 30 is made of an elastomer easily separable from the filler 14. In particular, the cover 30 is made of a thermoplastic elastomer. Preferred examples of the thermoplastic elastomer include a polystyrene-based thermoplastic elastomer, an olefin/alkene-based thermoplastic elastomer, a polyvinyl chloride-based thermoplastic elastomer, a polyurethane-based thermoplastic elastomer, a polyester-based thermoplastic elastomer, and a polyamide-based thermoplastic elastomer.

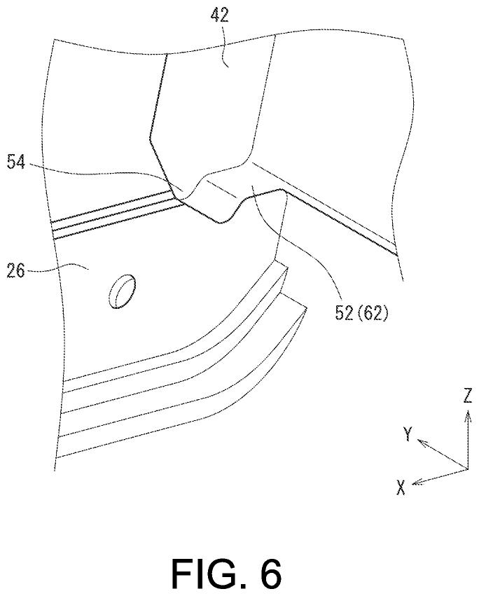

In FIG. 4, the double-headed arrow W1 represents the width of the outer iron core 28 as measured in the axial direction (leftward/rightward direction) of the iron core unit 32. The double-headed arrow W2 represents the width of the central iron core 26 as measured in the axial direction of the iron core unit 32. FIG. 6 is an enlarged perspective view showing a region indicated by the numeral VI of FIG. 5. This perspective view is one which shows the vicinity of the right end of the contact surface 52 of the first pillar portion 42 as viewed from the lower right side.

In this embodiment, the width W1 of the outer iron core 28 is greater than the width W2 of the central iron core 26. Thus, as shown in FIG. 6, the contact surface 52 of the outer iron core 28 projects out of the central iron core 26 in the axial direction of the iron core unit 32. In FIG. 6, the contact surface 52 projects rightward. Since the contact surface 52 projects in this manner, the right end portion of the contact surface 52 is exposed. The contact surface 52 includes a first exposed portion 62 at the right end thereof. Although not shown, the contact surface 52 of the outer iron core 28 projects leftward out of the central iron core 26. Since the contact surface 52 projects in this manner, the left end portion of the contact surface 52 is exposed. The contact surface 52 includes a second exposed portion at the left end thereof.

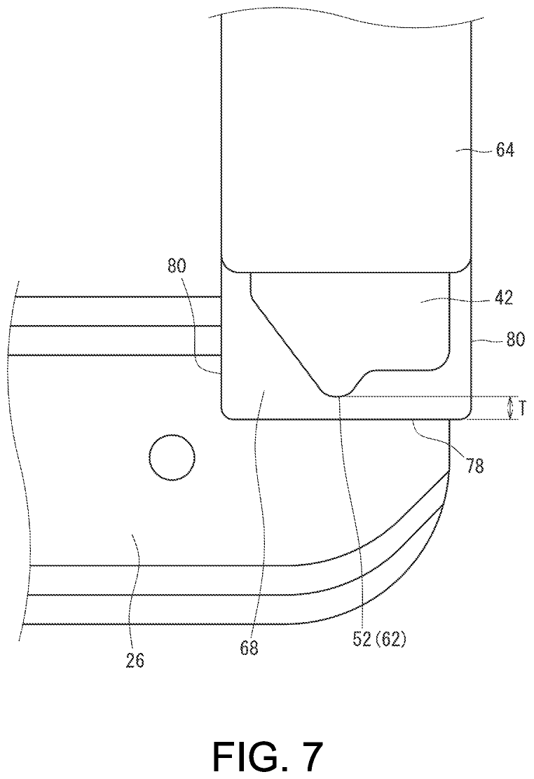

FIG. 7 is a side view showing the region of FIG. 6 with the cover 30 placed thereon. This side view is one which shows a region indicated by the numeral VII of FIG. 3. As shown in FIGS. 4 and 6, the first portion 56 of the cover 30 includes a main portion 64 and a first projecting portion 68 extending downward from the lower right end of the main portion 64.

As shown in FIG. 7, the first projecting portion 68 covers the first exposed portion 62 of the contact surface 52. In this embodiment, the first projecting portion 68 further covers a part of the front surface of the first pillar portion 42 and a part of the rear surface of the first pillar portion 42. In this embodiment, the thickness of the first projecting portion 68 as measured in the axial direction is smaller than the thickness of the main portion 64 as measured in the axial direction. Thus, while the main portion 64 covers the right side surface of the first pillar portion 42, the first projecting portion 68 does not cover the right side surface of the first pillar portion 42. As shown in FIG. 7, the outer contour of the first projecting portion 68 (the contour of that region of the first projecting portion 68 which is not in contact with the exposed portion 62) is rectangular when the first projecting portion 68 is viewed from outside in the axial direction (from the right side in this example). That is, the contour of the first projecting portion 68 includes a base 78 extending in the forward/rearward direction and a pair of sides 80 respectively extending upward from both ends of the base 78.

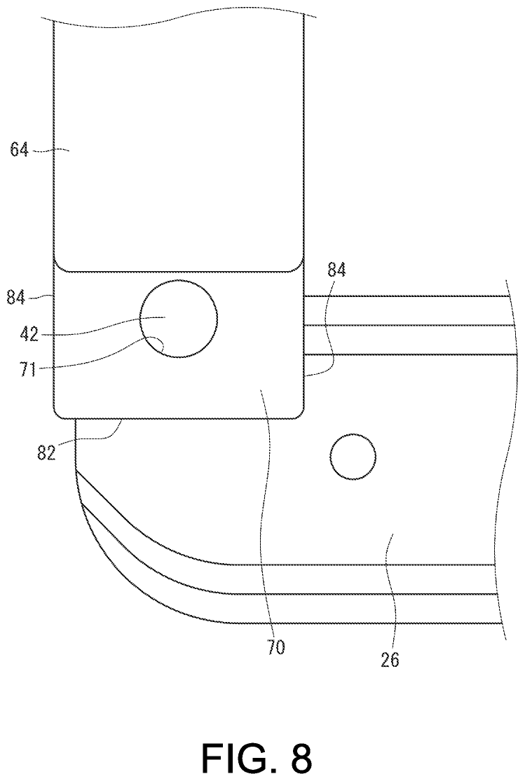

FIG. 8 is a side view showing the vicinity of the second exposed portion as viewed from the side (left side) opposite to that shown in FIG. 7. As shown in FIGS. 4 and 8 the first portion 56 of the cover 30 further includes a second projecting portion 70 extending downward from the lower left end of the main portion 64.

The second projecting portion 70 covers the second exposed portion of the contact surface 52. In this embodiment, the second projecting portion 70 further covers a part of the front surface of the first pillar portion 42 and the rear surface of the first pillar portion 42. In this embodiment, the second projecting portion 70 further covers the left side surface of the first pillar portion 42. The second projecting portion 70 includes a circular hole 71. A part of the left side surface of the first pillar portion 42 is exposed at the location of the hole 71. As shown in FIG. 8, the outer contour of the second projecting portion 70 is rectangular when the second projecting portion 70 is viewed from outside in the axial direction (from the left side in this example). That is, the contour of the second projecting portion 70 includes a base 82 extending in the forward/rearward direction and a pair of sides 84 respectively extending upward from both ends of the base 82.

In the embodiment of FIGS. 7 and 8, the first projecting portion 68 does not cover the right side surface of the first pillar portion 42, but the second projecting portion 70 covers the left side surface of the first pillar portion 42. The first projecting portion 68 may cover the right side surface of the first pillar portion 42 while the second projecting portion 70 does not cover the left side surface of the first pillar portion 42.

As shown in FIG. 1, the cap 31 is placed on the outer iron core 28, with the cover 30 interposed between the cap 31 and the outer iron core 28. The cap 31 is exposed outside the filler 14. The cap 31 protects the outer iron core 28 and the cover 30 from the outside environment. The cap 31 is made of a resin excellent in durability and weathering resistance. Preferred examples of the material of the cap 31 include PBT, PPS, and PET.

As previously described, the ignition coil 2 includes the connector portion 6, the flange portion 10, and the output portion 8 in addition to the body 4. The connector portion 6 is located ahead of the body 4. The connector portion 6 is tubular. The connector portion 6 is open at its front end. The connector portion 6 includes a connector terminal 72 therein. Although not shown, a plurality of connector terminals 72 are arranged in the leftward/rightward direction. When the ignition coil 2 is mounted on a vehicle, the connector terminals 72 are connected to a controller (ECU) of the vehicle. The connector terminals 72 are connected also to terminals of the igniter 16.

The flange portion 10 is located behind the body 4. The flange portion 10 includes a hole 74 extending therethrough in the upward/downward direction. Although not shown, a bolt is passed through the hole 74 and a hole located in an internal combustion engine to fix the ignition coil 2 to the internal combustion engine. Thanks to the flange portion 10, the ignition coil 2 is securely fixed to the internal combustion engine.

The output portion 8 is located below the body 4. The output portion 8 includes a high-voltage terminal 76 therein. The high-voltage terminal 76 is connected to a terminal of the secondary coil 24. Although not shown, the output portion 8 is inserted into a plug hole when the ignition coil 2 is mounted on a vehicle. The high-voltage terminal 76 is electrically connected to an ignition plug.

A method of producing the ignition coil 2 includes the following steps.
(1) Step of forming the primary coil 20
(2) Step of incorporating the central iron core 26
(3) Step of forming the secondary coil 24
(4) Step of forming the cover 30 around the outer iron core 28
(5) Step of incorporating the outer iron core 28
(6) Step of assembling all the components of the ignition coil 2

In the step (1), the primary wire is wound around the middle portion 18a of the primary bobbin 18 shown in FIG. 2, and thus the primary coil 20 is formed. In the step (2), the central iron core 26 is inserted into the hole 19 of the primary bobbin 18. In the step (3), the secondary bobbin 22 is placed on the outside of the primary coil 20, and the secondary wire is wound around the secondary bobbin 22.

In the step (4), the cover 30 is formed around the outer iron core 28 by insert molding. In this step, although not shown, the outer iron core 28 is placed into a cavity (space) of a mold. The outer iron core 28 is fixed in a given position within the cavity such that a gap corresponding in shape to the cover 30 is formed between the outer iron core 28 and the mold. This fixation is done by pressing opposite left and right parts of the outer iron core 28 toward each other. In this embodiment, that region of the right side surface of the second pillar portion 46 which is exposed outside the cover 30 and that region of the left side surface of the second pillar portion 46 which is exposed outside the cover 30 (see FIG. 3) are pressed toward each other to clamp the outer iron core 28. Additionally, that region of the right side surface of the first pillar portion 42 which is exposed without being covered by the first projecting portion 68 (see FIG. 7) and that region of the left side surface of the first pillar portion 42 which is exposed through the hole 71 (see FIG. 8) are pressed toward each other to clamp the outer iron core 28. Once the outer iron core 28 is fixed, a hot-melt liquid of elastomer is poured into the gap between the outer iron core 28 and the mold. The poured elastomer is cooled and cured, and thus the cover 30 is formed around the outer iron core 28.

The step (4) may be performed before or after the steps (1), (2), and (3). The step (4) may be performed concurrently with the steps (1), (2), and (3).

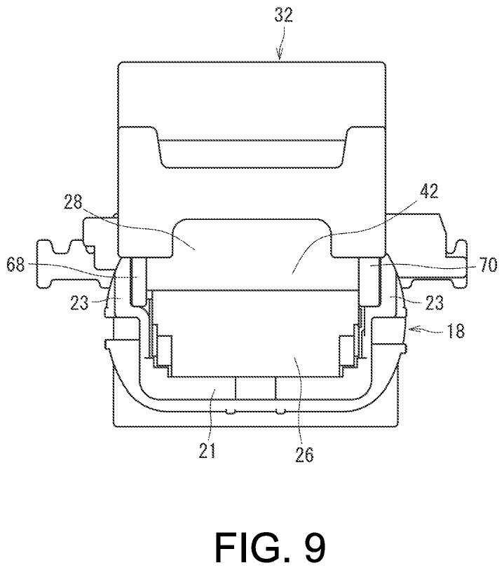

In the step (5), the outer iron core 28 with the cover 30 formed in the step (4) is incorporated with the structure resulting from the step (3). FIG. 9 is a rear view showing the iron core unit 32 and primary bobbin 18 as viewed when the outer iron core 28 is incorporated. As shown in FIG. 9, the receiving portion 21 of the rear portion 18c of the primary bobbin 18 covers a rear end portion of the central iron core 26. The outer iron core 28 is incorporated such that the contact surface 52 of the outer iron core 28 is in contact with the contact surface 40 of the central iron core 26. Further, as shown in FIG. 9, the outer iron core 28 is incorporated such that the left side surface of the first pillar portion 42 with the cover 30 formed thereon is in contact with the left wing portion 23 of the primary bobbin 18. The outer iron core 28 is fixed in position by such contact. The wing portion 23 facilitates the positioning of the outer iron core 28 in the leftward/rightward direction (axial direction).

In another embodiment, the outer iron core 28 may be positioned such that the right side surface of the first pillar portion 42 is in contact with the right wing portion 23 of the rear portion 18c of the primary bobbin 18. In this instance, the width of the second projecting portion 70 in the axial direction is defined such that the second projecting portion 70 does not deform by interfering with the central iron core 26 upon contact of the outer iron core 28 with the right wing portion 23.

In the step (6), the structure resulting from the step (5) is placed into the case 12 together with the igniter 16, and a thermosetting resin is poured into gaps within the case 12. The thermosetting resin is heated to form the filler 14. Thus, the ignition coil 2 is obtained.

The following will describe the advantageous effects of the present embodiment.

In the ignition coil 2, the width W1 of the outer iron core 28 is greater than the width W2 of the central iron core 26 in the axial direction (leftward/rightward direction) of the iron core unit 32. The outer iron core 28 can have a greater width than the central iron core 26 whose width is limited by the presence of the primary bobbin 18 around the central iron core 26. The ignition coil 2 exhibits excellent performance thanks to the fact that the width W1 of the outer iron core 28 is greater than the width W2 of the central iron core 26.

In the ignition coil 2, since the width W1 of the outer iron core 28 is greater than the width W2 of the central iron core 26, the contact surface 52 of the outer iron core 28 includes the first exposed portion 62 and the second exposed portion which project out of the central iron core 26 and are exposed to the outside environment. The cover 30 includes the first projecting portion 68 covering the first exposed portion 62 and the second projecting portion 70 covering the second exposed portion. The first projecting portion 68, which is made of an elastomer, effectively prevents the filler 14 from suffering from cracking attributed to the first exposed portion 62. The second projecting portion 70, which is made of an elastomer, effectively prevents the filler 14 from suffering from cracking attributed to the second exposed portion. The ignition coil 2 is resistant to cracking in the filler 14.

The ignition coil 2 may include only the first exposed portion 62. In this instance, the cover 30 need not include the second projecting portion 70. The ignition coil 2 may include only the second exposed portion. In this instance, the cover 30 need not include the first projecting portion 68.

The thickness of the cover 30 at a given point on the exposed portion 62 is measured in a direction perpendicular to the exposed portion 62 at the given point. The double-headed arrow T of FIG. 7 represents the minimum thickness of that portion of the cover 30 which covers the first exposed portion 62. In this embodiment, the thickness T is the thickness of the cover 30 as measured at the lower end of the protrusion 54 of the bottom surface 50 of the first pillar portion 42. The thickness T is preferably 0.5 mm or more. When the thickness T is 0.5 mm or more, the first projecting portion 68 effectively prevents the filler 14 from suffering from cracking attributed to the first exposed portion 62. In view of this, the thickness T is more preferably 0.7 mm or more. In view of reducing the likelihood that the cover 30 becomes an obstacle to the other components, the thickness T is preferably 2 mm or less.

The thickness T of that portion of the cover 30 which covers the second exposed portion is also preferably 0.5 mm or more and more preferably 0.7 mm or more for a similar reason to that described above. The thickness T of that portion of the cover 30 which covers the second exposed portion is also preferably 2 mm or less.

In this embodiment, the outer contour of the first projecting portion 68 is rectangular when the iron core unit 32 is viewed from one side (right side) in the axial direction. This allows for easy formation of the first projecting portion 68 and easy assembly of the ignition coil 2. Further, in this embodiment, the outer contour of the second projecting portion 70 is rectangular when the iron core unit 32 is viewed from the other side (left side) in the axial direction. This allows for easy formation of the second projecting portion 70 and easy assembly of the ignition coil 2.

In this embodiment, the contact surface 52 of the first pillar portion 42 includes the protrusion 54, and the contact surface 40 of the central iron core 26 includes the recess 38 shaped to conform to the protrusion 54. The protrusion 54 is fitted in the recess 38. This prevents misalignment between the contact surface 52 of the first pillar portion 42 and the contact surface 40 of the central iron core 26 in the forward/rearward direction. For example, the first pillar portion 42 is prevented from being displaced rearward and having its contact surface 52 exposed rearward. This leads to prevention of cracking in the filler 14 and at the same time contributes to excellent performance of the ignition coil 2.

The contact surface 52 of the first pillar portion 42 may include a recess, the contact surface 40 of the central iron core 26 may include a protrusion shaped to conform to the recess, and the protrusion may be fitted in the recess. The contact surface 52 of the first pillar portion 42 may include no protrusion or recess. The contact surface 40 of the central iron core 26 may include no recess or protrusion.

In this embodiment, the first projecting portion 68 does not cover the right side surface of the outer iron core 28. This is because during insert molding, the outer iron core 28 is clamped at that uncovered region of the outer iron core 28. The clamping prevents displacement of the outer iron core 28 during insert molding. As such, the cover 30 can be accurately formed. This contributes to preventing cracking in the filler 14. In this embodiment, the second projecting portion 70 covers the left side surface of the outer iron core 28, except for the region exposed through the hole 71. The second projecting portion 70 contributes to preventing cracking in the filler 14. Thanks to the fact that only one of the first and second projecting portions 68 and 70 covers a side surface of the outer iron core 28, cracking in the filler 14 can be effectively prevented.

In this embodiment, the primary bobbin 18 includes the wing portion 23 in contact with a side surface of the outer iron core 28. In the production of the ignition coil 2, the outer iron core 28 can be fixed in position by bringing the side surface of the outer iron core 28 into contact with the wing portion 23. This facilitates the production of the ignition coil 2.

According to the present embodiment, as described above, an ignition coil adapted to avoid the occurrence of cracking in a filler can be obtained. This demonstrates the superiority of the present embodiment.

### [Disclosed Items]

The following items are disclosures of preferred embodiments.

### [Item 1]

An ignition coil including:
a primary coil;
a secondary coil formed outside the primary coil; and
an annular iron core unit, wherein
the iron core unit includes:
   a central iron core extending through the primary coil;
   an outer iron core having a contact surface in contact with the central iron core, the outer iron core extending from one end of the central iron core and passing outside the secondary coil; and
   a cover made of an elastomer,
the contact surface includes an exposed portion projecting out of the central iron core in an axial direction of the iron core unit, and
the cover includes a projecting portion covering the exposed portion.

### [Item 2]

The ignition coil according to item 1, wherein a thickness of the projecting portion is 0.5 mm or more.

### [Item 3]

The ignition coil according to item 1 or 2, wherein an outer contour of the projecting portion is rectangular when the projecting portion is viewed from outside in the axial direction of the iron core unit.

### [Item 4]

The ignition coil according to any one of items 1 to 3, wherein
the contact surface includes a protrusion or recess extending in the axial direction of the iron core unit, and
a portion of the central iron core that is in contact with the contact surface includes a recess shaped to conform to the protrusion of the contact surface or a protrusion shaped to conform to the recess of the contact surface.

### [Item 5]

The ignition coil according to any one of items 1 to 4, wherein
the contact surface includes:
   a first exposed portion projecting out of one side of the central iron core in the axial direction of the iron core unit; and
   a second exposed portion projecting out of another side of the central iron core in the axial direction of the iron core unit,
the cover includes:
   a first projecting portion covering the first exposed portion; and
   a second projecting portion covering the second exposed portion, and only one of the first and second projecting portions further covers an outer surface of the outer iron core, the outer surface facing in the axial direction of the iron core unit.

The ignition coil as described above is usable in various internal combustion engines.

The foregoing description is given for illustrative purposes, and various modifications can be made without departing from the principles of the present invention.

What is claimed is:

1. An ignition coil comprising:
a primary coil;
a secondary coil formed outside the primary coil; and
an annular iron core unit, wherein
the iron core unit includes:
a central iron core extending through the primary coil;
an outer iron core having a contact surface in contact with the central iron core, the outer iron core extending from one end of the central iron core and passing outside the secondary coil; and
a cover made of an elastomer,
the contact surface includes an exposed portion projecting out of the central iron core in an axial direction of the iron core unit, and
the cover includes a projecting portion covering the exposed portion.

2. The ignition coil according to claim 1, wherein a thickness of the projecting portion is 0.5 mm or more.

3. The ignition coil according to claim 1, wherein an outer contour of the projecting portion is rectangular when the projecting portion is viewed from outside in the axial direction of the iron core unit.

4. The ignition coil according to claim 1, wherein
the contact surface includes a protrusion or recess extending in the axial direction of the iron core unit, and
a portion of the central iron core that is in contact with the contact surface includes a recess shaped to conform to the protrusion of the contact surface or a protrusion shaped to conform to the recess of the contact surface.

5. The ignition coil according to claim 1, wherein
the contact surface includes:
a first exposed portion projecting out of one side of the central iron core in the axial direction of the iron core unit; and
a second exposed portion projecting out of another side of the central iron core in the axial direction of the iron core unit,
the cover includes:
a first projecting portion covering the first exposed portion; and
a second projecting portion covering the second exposed portion, and
only one of the first and second projecting portions further covers an outer surface of the outer iron core, the outer surface facing in the axial direction of the iron core unit.
